(19) United States
(12) Patent Application Publication
(10) Pub. No.: US 2017/0182861 A1
(43) Pub. Date: Jun. 29, 2017

(54) AUXILIARY HEATING, VENTILATION, AND AIR CONDITIONING SYSTEM AND METHOD

(71) Applicant: Gentherm Incorporated, Northville, MI (US)

(72) Inventors: Adam Joseph Steinman, Ferndale, MI (US); Darren Andrew Schumacher, Ann Arbor, MI (US); Maurice Edward Phiullips Gunderson, Orinda, CA (US); David Thomas, Royal Oak, MI (US); Wayne Swoyer Kauffman, III, Oak Park, MI (US)

(21) Appl. No.: 15/325,277

(22) PCT Filed: Jul. 23, 2015
(86) PCT No.: PCT/US2015/041660

§ 371 Date: Jan. 10, 2017

Related U.S. Application Data
(60) Provisional application No. 62/028,036, filed on Jul. 23, 2014.

(51) Int. Cl. B60H 1/00; B60S 1/54; B60H 1/22

(52) U.S. Cl. CPC B60H 1/00028; B60H 1/00785; B60H 1/2225; B60H 1/00064; B60S 1/54; B60H 2001/00221; B60H 2001/2293

(57) ABSTRACT

Disclosed embodiments include an automotive heating, ventilation, and air-conditioning (HVAC) system (12) for an interior of a vehicle (10), comprising: an auxiliary HVAC system (32) that provides conditioned air to the interior, the auxiliary HVAC system including an auxiliary air conditioning device (50); a control module that operates the auxiliary HVAC system independently of the central HVAC system (30); and one or more sensors for detecting, calculating, or both when fog, ice, condensation, or a combination thereof are located on a window of an automobile; wherein the central HVAC system includes a central air conditioning device (40) that is separate from the auxiliary air conditioning device (50).

### FIELD

The present teachings relate generally to automotive heating, ventilation and air-conditioning (HVAC) systems and methods, and more particularly to auxiliary HVAC systems for defrosting and defogging or demisting side windows.

### BACKGROUND

Automotive vehicles include a central or main HVAC system that provides conditioned air to a passenger compartment for occupant comfort and clearing windows of frost and fog. Conventional central HVAC systems employ vapor compression refrigeration. The central or main HVAC systems remove condensation from the windows, however, due to the size of the system the entire vehicle space may be heated or cooled causing the occupants to become hot or cold. Attempts have been made to create smaller systems to clear windows some examples of which are found in U.S. Pat. Nos. 2,133,488; 3,763,761; 5,718,375; 5,844,202; 5,987,216; and 7,331,531 and U.S. Patent Application Publication No. 2009/0270023 the teachings of which are expressly incorporated by reference herein in their entirety for all purposes.

### SUMMARY

The present disclosure provides an auxiliary HVAC system that operates alone or in combination with a conventional central HVAC system, and provides improved occupant comfort and window clearing over conventional central HVAC systems.

The present teachings include: an automotive heating, ventilation, and air-conditioning (HVAC) system for an interior of a vehicle, comprising: a central HVAC system that provides conditioned air to the interior, the central HVAC system including a first air conditioning device; and an auxiliary HVAC system that provides conditioned air to the interior, the auxiliary HVAC system including a second air conditioning device separate from the first air conditioning device; and a control module that operates the central and auxiliary HVAC systems independently.

The present teachings include: a method comprising: (a) providing an auxiliary HVAC system of the teachings herein within the interior space of an automotive vehicle; (b) monitoring one or more ambient conditions with the one or more sensors; (c) calculating whether the one or more monitored ambient conditions in step b. provide that conditions for formation of fog, ice, condensation, or a combination thereof on the one or more windows of the automobile are present; and (d) automatically operating the auxiliary HVAC system when the conditions calculated in step c. indication that fog, ice, condensation, or a combination thereof are present.

The present teachings provide: a method comprising: (a) providing the auxiliary HVAC system of the teachings herein, (b) locating the auxiliary HVAC system within an interior space of an automotive vehicle; (c) monitoring one or more ambient conditions with the one or more sensors;—(d) determining whether the one or more ambient conditions for forming fog, ice, condensation, or a combination thereof on one or more windows of the automobile are present; and (e) automatically operating the auxiliary HVAC system based on the presence of the ambient conditions determined in step d.

The present teachings provide: a method comprising: (a) auxiliary HVAC system of any of the preceding claims within the interior space of an automotive vehicle; (b) monitoring one or more ambient conditions with the one or more sensors; and (c) calculating whether the ambient conditions provide that fog, ice, condensation, or a combination thereof being present the one or more windows of the automobile.

### BRIEF DESCRIPTION OF THE DRAWINGS

Various embodiments are depicted in the accompanying drawings for illustrative purposes, and should in no way be interpreted as limiting the scope of the systems and methods disclosed herein. In addition, various features of different disclosed embodiments can be combined with one another to form additional embodiments, which are part of this disclosure. Any feature or structure can be removed, altered, or omitted. Throughout the drawings, reference numbers may be reused to indicate correspondence between reference elements.

FIG. 1 is a block diagram schematically illustrating an exemplary HVAC system for a vehicle according to the present disclosure.

FIG. 2 is a block diagram schematically illustrating an exemplary HVAC control system for a vehicle according to the present disclosure.

FIG. 3 is a perspective view of an exemplary side door trim panel for a vehicle according to the present disclosure.

FIG. 4 is a side view of the side door trim panel shown in FIG. 3.

FIG. 5 is a side view schematically illustrating a portion of an exemplary side window conditioning module according to the present disclosure.

FIG. 6 is a schematic view illustrating operation of a side window conditioning module according to the present disclosure.

FIG. 7 is a flow diagram illustrating an exemplary control method for an auxiliary HVAC system for a vehicle according to the present disclosure.

FIG. 8 is a flow diagram illustrating another exemplary control method for an auxiliary HVAC system for a vehicle according to the present disclosure.

FIG. 9 is a schematic view of another auxiliary HVAC system according to the present disclosure.

FIG. 10 is a flow diagram illustrating another exemplary control method for an auxiliary HVAC system for a vehicle according to the present disclosure.

FIG. 11 is a perspective view illustrating outlets in fluid communication with an auxiliary HVAC system for a vehicle according to the present disclosure.

FIG. 12 is a front view of another exemplary auxiliary HVAC system for a vehicle according to the present disclosure.

FIG. 13 is a front view of another exemplary auxiliary HVAC system for a vehicle according to the present disclosure.

FIG. 14 is a flow diagram illustrating control for automatically controlling an auxiliary HVAC system.

FIG. 15A illustrates an auxiliary HVAC system and sensing configuration.

FIG. 15B illustrates an auxiliary HVAC system and sensing configuration.

FIG. 15C illustrates an auxiliary HVAC system with humidity sensors.

FIG. 15D illustrates an auxiliary HVAC system connected to a temperature sensor and a humidity sensor.

### DETAILED DESCRIPTION

The present teachings are illustrated by embodiments and examples disclosed herein, however the present teachings apply beyond the examples and embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Those of skill in the art will appreciate that the term control module as used herein can refer to, be a part of, or comprise a processor that executes code; an Application Specific Integrated Circuit (ASIC); an electronic circuit; a combinational logic circuit; a field programmable gate array (FPGA); a hard-wired feedback control circuit; other suitable components that provide the described functionality; or a combination of some or all of the foregoing. The control module can further comprise memory (shared, dedicated, or group) that stores code executed by the control module.

The vehicle may be a passenger vehicle, SUV, truck, commercial vehicle, or any other vehicle where one or more windows may become partially or fully covered in fog, or partially or fully impair a user's vision out of the one or more windows. The vehicle includes a primary HVAC system and an auxiliary HVAC system. The primary HVAC system provides the general heating and air conditioning to the interior location so that an occupant is heated and/or cooled while located within the vehicle. As discussed herein an air conditioning device is any device that allows for the removal of fog, ice, condensation, or a combination thereof from a window. The air conditioning device may be a heater module, but could be an air conditioner that removes humidity or water from an air stream effectively drying the air. The primary HVAC system may be substantially located within the engine compartment of the vehicle. The system as discussed herein preferably includes both a primary HVAC and an auxiliary HVAC system. Preferably, the auxiliary HVAC system is located within an interior compartment of a vehicle in close proximity to one or more windows.

The auxiliary heating and air conditioning system (hereinafter auxiliary HVAC) may function to remove condensation, ice, fog, snow, condensation, or a combination thereof (hereinafter fog) from one or more windows of a vehicle, or when conditions are likely to exist. The auxiliary HVAC system may preferably work independently from a primary HVAC system of the vehicle or together with all or a portion of the primary HVAC to remove fog from one or more windows. The auxiliary HVAC may remove fog from virtually any window although the auxiliary HVAC is used with vehicle windows. The auxiliary HVAC system may be located within an interior compartment, a movable member, or both of a vehicle.

The one or more interior compartments may function to carry one or more passengers. The one or more interior compartments may include one or more windows that an occupant may look through, and preferably look through to control a vehicle. The one or more interior compartments may include one or more dash boards, windows, foot wells, steering wheels, or a combination thereof where one or more occupants reside. The one or more interior compartments have ambient conditions (e.g., temperature, humidity, barometric pressure, or a combination thereof). The ambient conditions inside of the interior compartment may be substantially the same as the ambient conditions outside of the interior compartment (i.e., external). However, when the ambient conditions inside of the interior compartment are different than the ambient conditions external to the interior compartment fog may appear on the inside of the windows, the outside of the windows, or both. The one or auxiliary HVAC systems may be wholly or partially located within the interior compartment. The one or more auxiliary HVAC system may direct air between two or more locations within the interior compartment. The one or more auxiliary HVACs may direct conditioned air between one or more fogged windows, between a window and a secondary location, from a window to a foot well, from a window to another location within the interior compartments, or a combination thereof. The interior compartment may be accessed by one or more movable members and each of the movable members may include one or more windows.

The one or more movable members may function to allow a user to access the interior compartment. The one or more movable members may be a door, a gate, hatch, the like, or a combination thereof. The one or more movable members may be connected by one or more hinges. The one or more movable members may move laterally, longitudinally, rotationally, along a track, or a combination thereof. The one or more movable members may lock when in a closed position. The one or more movable members may have a width that is sufficiently large to allow a window to move up and down and be located internally within the movable member. The one or more movable members may include a cage for crash protection. Preferably, the one or more movable members is a door panel that is moved to allow a user access to a vehicle. The one or more movable members may include all or a portion of an auxiliary HVAC system. The movable member may include one or more ports that permit air to be removed from outside of the vehicle, an interior compartment, outside of the movable members, or a combination thereof. The auxiliary HVAC system may circulate conditioned air within the movable member, the interior compartment, or both via ducting.

The ducting (as discussed herein ducting may be one duct or a plurality of ducts) may function to move air from an air moving device, an air conditioner, a heater module, or a combination thereof. The ducting may direct air from an air mover to a location of interest. Preferably, the ducting directs air from an air mover, a heater module, or both to a fogged location. The ducting may direct air from one location within an interior compartment to a second location within the interior compartment. The ducting may primarily direct air to a window and secondarily direct air for heating a select region such as a foot well, steering wheel, hands, feet, side of a foot well, top of a foot well, a shifter, from a movable member to legs of an occupant, or a combination thereof. The ducting may direct conditioned air to a desired location a fogged location, or both and then venting may distribute the conditioned air.

The venting may function to distribute air to one or more locations of interest, to a location that includes fog, or both. The venting may distribute air on an occupant, at regions that include an occupant, or both. The one or more vents may evenly distribute air along a length or a width of a window. The one or more vents may direct air into common locations where a user looks through a window. The one or more vents may prevent debris from being introduced into the auxiliary HVAC system. The one or more vents may extend through one or more vehicle components such as a door panel, a console, a dashboard, or a combination thereof. The one or more vents preferably may direct fluid to one or more windows so that fog is removed from the windows when the auxiliary HVAC device is on. The one or more vents may distribute air as the air is directed to one or more of the vents by one or more valves and preferably one or more proportioning valves.

The one or more valves may function to direct air between two or more locations of interest. The one or more valves may switch air from a first location to a second location. The one or more valves may direct air from an air mover through a heater module, around the heater module, or both. The one or more valves may switch the location of air based upon a signal from a controller. The one or more valves may switch the location of air based upon a predetermined time. The one or more valves may proportion air between a location for removing fog and a location for providing air to an occupant. The one or more valves may be proportioning valves that may manually, automatically, or both direct air between two or more locations. The one or more valves may be controlled by a user interface.

The user interface may function to control the auxiliary HVAC. The user interface may be part of the control system of a vehicle. The user interface may be discrete from the control system of a vehicle. The user interface may allow a user to turn on and off the auxiliary HVAC system when fog is present. The user interface may be an on/off switch, a temperature switch, a direction switch, or a combination thereof. The user interface may switch between a summer mode and a winter mode. The user interface may be one or more buttons, a touch screen display, or both. The user interface may be part of the primary HVAC system so that the primary HVAC and the auxiliary HVAC work together to condition the internal compartment. The user interface may connect with one or more control modules. The user interface may allow a user to direct one or more inputs to one or more control modules (e.g., a central HVAC control module or an auxiliary HVAC control module). The user interface may direct user inputs to the control modules, and other inputs may be directed to the control module separate from the user inputs.

The other inputs may function to provide feedback, signals, measurements, or a combination thereof so that the control module (e.g., auxiliary, central, or both) may automatically control the auxiliary HVAC. The other inputs may be one or more signals from one or more sensors. The other inputs may be from a computer of the vehicle. One or more of the other inputs may be used together to automatically control the auxiliary HVAC. Two or more of the other inputs may be used to automatically control the auxiliary HVAC. One or more and preferably two or more other inputs may be compared to a look up table to determine a dew point, a likelihood of condensation, or both. A dew point may be calculated using one or more and preferably two or more other inputs and compared to an external temperature to determine whether fog, condensation, ice, or a combination thereof will occur on an internal surface of a vehicle such as a window. The other inputs may be internal temperature sensor, external temperature sensor, internal humidity sensor, external humidity sensor, a rain sensor, or a combination thereof. The temperature sensors may measure a temperature of an internal component and/or a component external to the interior compartment. For example, the temperature sensor may measure a temperature of an internal side of a window, an external side of a window, or both. Preferably, the temperature sensors measure temperature of air within the internal of the vehicle external to the interior of the vehicle, or both. Most preferably, there is no direct temperature measurement of the windows of the vehicle. The temperature sensor may not be in direct contact with a window, glass, or both. The temperature sensor may monitor air temperature within the vehicle, outside of the vehicle, or both. The other inputs may be an input from a look up table. The look up table may include dew points based upon temperature, humidity, barometric pressure, or a combination thereof. In one preferred example, the dew point is first calculated based upon the internal temperature and internal humidity and then the internal dew point the internal dew point is then compared to the external temperature to determine the likelihood that condensation will occur on one or more of the windows. The temperature, humidity, barometric pressure, or a combination thereof may be obtained by one or more sensors.

The one or more sensors may be a temperature sensor, a humidity sensor, a pressure sensor, a rain sensor, or a combination thereof. The temperature sensor may function to measure an ambient temperature of a region around the temperature sensor. The temperature sensor may be a thermocouple, a resistive temperature device, an infrared sensor, a bimetallic device, a thermometer, a change-of-state sensor, a silicon dioxide, or a combination thereof. The temperature sensors preferably do not measure a temperature of a surface, but measure the temperature of the air around the surface. The humidity sensors may be a capacitive humidity sensor, a resistive humidity sensor, a thermal conductivity humidity sensor, or a combination thereof. The humidity sensor may function to measure an ambient humidity of a region around the humidity sensor. The barometric pressure sensor may function to measure an ambient barometric pressure of a region around the barometric pressure sensor. The barometric pressure sensors may be a water-based barometer, vacuum pump oil barometer, aneroid barometer, MEMS barometers, or a combination thereof. The one or more rain sensors may measure an amount of fog within a given location. The one or more rain sensors may be an optical rain sensor, an infrared light sensor, or both. The other inputs, the user interface inputs or both may be directed to an HVAC control module and preferably an HVAC auxiliary control module.

The control module may function to control the auxiliary HVAC system. The control module may function to automatically turn the auxiliary HVAC on and off. The control module may direct conditioned air to one or more locations. The control module may control the temperature of air, the duration the auxiliary HVAC is used, the locations of the air directed from the vents, the valves, or a combination thereof. The control module may adjust usage based upon user inputs, other inputs, or both. The control module may control the volume of air moved by the one or more air moving devices, the change in temperature by the heater module, the decrease in humidity, or a combination thereof. The control module may adjust the output of the heater module, the speed of air moving device, or both so that the air changes in temperature by about 5° C. or more, preferably about 10° C. or more, more preferably about 12° C. or more, or even about °15 C. or more by the heater module. The control module may be a standalone control module, part of the central control module, or a combination of both. The control module may control one or more air moving devices, one or more valves, one or more vents, one or more deflectors, or a combination thereof.

The one or more air moving devices (hereinafter AMD) may function to move air to a location of interest, through a heater module, through ducting, through one or more valves, through venting, or a combination thereof. The one or more AMDs may me a fan. Preferably, the one or more AMDs are a blower. More preferably, the AMDs is a radial blower that directs air through a heater module and to one or more locations of interest. The one or more AMD's may move enough air so that the auxiliary HVAC may defog a side window in about 5 minutes or less, about 3 minutes or less, or even about 1 minute or less. The one or more AMD alone or in combination may each move about 8 cubic m/hr or more, about 11 cubic m/hr or more, or preferably about 15 cubic m/hr or more. The one or more AMD alone or in combination may move about 85 cubic m/hr or less, about 60 cubic m/hr or less, or about 45 cubic m/hr or less. The one or more AMD's may be two blowers used in parallel. Preferably, only one AMD is used within the auxiliary HVAC. The one or more AMDs include one or more inlets, one or more outlets, or both. The one or more AMDs may obtain air from one or more locations. When the AMD draws air from more than one location the inlet of the AMD may be connected to ducting that connects the AMD to multiple different locations. The multiple locations may prevent cavitation of the AMD. The multiple locations may feed the inlet so that the inlet is constantly provided with air.

The one or more inlets may function to receive air into the AMD and direct air to an impeller so that air is directed out of the AMD. The one or more inlets may pull air into the AMD. The one or more inlets may be generally circular. The one or more inlets may include a cover. The one or more inlets may receive air from inside of an interior compartment, a movable member, of both. The one or more inlets may be located at about a 90 degree angle from one or more outlets.

The one or more outlets may function to direct air through a heater module, to ducting, to a vent, or a combination thereof. The one or more outlets direct air into ducting that directs the air through a heater module. The one or more outlets may be located radially outward of the impeller. The one or more outlets may be movable. The one or more outlets may be adjusted on a window, within the interior compartment, or both. The one or more outlets may be adjusted within a servo motor, a stepper motor, by movement of another component, or a combination thereof. For example, if the vehicle includes movable pedals the outlet may be moved with the pedal so that the outlet is a standard distance from the pedals. The one or more outlets may be directly connected to one or more heater modules.

The one or more heater modules may function to heat air as the air passes there through. The one or more heater modules may be thermoelectric device, a Peltier device, a positive temperature coefficient heating device, a negative temperature coefficient heating device, a self-regulating heater, a wire heater, a heater that includes one or more fins, a heater that is connected to one or more heat exchangers, Carbotex®, or a combination thereof. The one or more heater modules heat air as the air mover moves air to a location of interest. The one or more heater modules may be sufficiently large so that the air changes temperature by about 5° C. or more, about 10° C. or more, about 12° C. or more, about 15° C. or more, or even about 20° C. or more. The one or more heater modules may be connected to or include one or more deflectors.

The one or more deflectors may function to direct air to specific locations. The one or more deflectors may function to spread the air out so that a vent may cover an area substantially larger than the area of the vent itself. The one or more deflectors may be internal features located within a ducting part. The one or more deflectors may be located inward from an escutcheon. The one or more deflectors may guide the air so that as the air exits the escutcheon the air spreads out, fans out, or both. The one or more deflectors may be made of the same material as the ducting parts and may be barriers within the ducting parts that extend from a first side to a second side and guide the air through the ducting parts. The one or more deflectors may be static, adjustable, removable, permanent, or a combination thereof. The one or more deflectors may be molded in the ducting. The one or more deflectors may be generally flat, arranged at progressively greater angles with respect to a longitudinal axis, have at least one of the deflectors is longer than the remaining deflectors, or a combination thereof. The one or more deflectors may be located downstream of the heater module so that the heated air is directed to a specific location. Preferably, a plurality of deflectors are located within the ducting parts between the heater module and the outlet or escutcheon.

The one or more ducting parts may function to guide air from the AMD to a location of interest. The one or more ducting parts may extend from an AMD to a heater module. The one or more ducting parts may connect to an AMD at an isolated or remote location and transfer the air under pressure to a location of interest. The one or more ducting parts may be made of a pliable material, a solid material, include rubber, include plastic, include joints that expand and contract, or a combination thereof. The one or more ducting parts may be two ducting parts that are connected together. The one or more ducting parts may include one or more attachments and preferably a plurality of attachments for connecting the one or more ducting parts to a location within a vehicle.

The one or more attachments may function to connect the auxiliary HVAC system or at least the auxiliary HVAC device within an interior compartment and preferably within a movable member. The one or more attachments may connect the auxiliary HVAC to a door panel, a trim panel, or both. The one or more attachments may receive a fastener for connecting at least a portion of the auxiliary HVAC system within a part of a vehicle. The one or more fasteners may be a screw, a clip, a christmas tree, a plastic clip, a metal clip, a wire, a clip that connects to an internal frame, a movable clip, a clip with dampening features, a clip with rubber, or a combination thereof. The one or more attachments may receive the fastener or may be integrally formed with a fastener. The one or more attachments may be located on opposing sides or opposing edges so that a thinnest part (e.g., thickness, height, width) of the ducting parts, the AMD, or both extends within a part of a vehicle. The attachments, the ducting parts, the deflectors, or a combination thereof may assist in holding the heater module within the ducting parts.

One or more retainers may be located within the ducting parts and may function to retain the heater module within the ducting parts. The one or more retainers may form an interference fit within the ducting parts so that the heater module is substantially prevented from moving. The one or more retainers may be located within a groove in the ducting parts to prevent movement of the heater module. The one or more retainers may be fitted between two opposing pieces of the ducting parts when the ducting parts are connected together. The one or more retainers may be an integral part of the ducting parts. The one or more retainers may be a discrete part that may be added after the heater module is added within the ducting parts.

The auxiliary HVAC may be controlled manually, automatically, or both. The automatic control may monitor one or more sensors. The automatic control may turn on when a predetermined condition is met (e.g., a dew point, conditions for fogging, or freezing temperatures). The automatic control may turn off when the predetermined condition is no longer met (e.g., a certain temperature, humidity, time, the vehicle is warm). The automatic control may turn off when the dew point drops below a temperature where condensation will occur. The automatic control may turn off when a certain temperature is achieved. The automatic control may move air from a first location of interest to a second location of interest when a predetermined condition is met, a predetermined condition is no longer met, or both. The automatic control may operate a portioning valve so that air is moved from a first location (e.g., window) to a second location (e.g., feet). The automatic control may turn on, off, or both when a user set point, a programmed set point, a calculated dew point, or a combination thereof is calculated, measured, achieved, or a combination thereof. The automatic control may compare a temperature, a humidity, or both to a look up table to determine a dew point. An internal temperature, internal humidity, or both may be compared to an external temperature, an external humidity, or both to determine a dew point, a possibility of fog forming, freezing, or a combination thereof. An internal temperature and an internal humidity may be compared and when the temperature achieves a certain humidity the auxiliary HVAC may be turned on regardless of the external temperature, humidity, or both. For example, if the internal humidity is greater than 80% and the internal temperature is less than 25° C. the auxiliary HVAC may automatically turn on. The internal temperature and internal humidity may be used to calculate the internal dew point and then the internal dew point may be compared to the external temperature and a look up table to determine if condensation will occur under those conditions. If condensation will occur under the measured conditions then the auxiliary HVAC system will be turned on. The controller may be connected only to an internal humidity sensor. The controller may monitor the internal humidity and if the internal humidity exceeds a predetermined percentage the auxiliary HVAC may automatically be turned on. For example, if humidity is detected over 70 percent the auxiliary HVAC may be turned on and once the humidity drops below 70 percent the auxiliary HVAC may be turned off. The auxiliary HVAC may be switched between a summer setting and a winter setting. In the winter setting the humidity level may be lower than in the summer setting. For example, in a winter setting the auxiliary HVAC may automatically turn on when the humidity achieves 30 percent or more and in the summer setting the auxiliary HVAC system may automatically turn on when the humidity achieves 60 percent or more. The auxiliary HVAC system may automatically turn on when humidity is 60 percent or more, 70 percent or more, or even 80 percent or more. A controller may monitor a rain sensor for external humidity, condensation, precipitation, or a combination thereof. The automatic control may turn on the one or more AMDs, the one or more heater modules, or both. The automatic control may only measure an internal humidity to determine whether to turn the auxiliary HVAC on or off. The automatic control may switch a location of the air stream from a window to another location such as a foot well, on a hand, on a shifter, on a leg, or a combination thereof. The control module may control a proportioning valve so that the air is proportioned or controlled between two or more locations. The control module of the auxiliary HVAC may communicate with the central control module. The auxiliary control module may receive information from the central control module. The auxiliary control module may receive all of the signals from the sensors and determine the status of the auxiliary HVAC system. The auxiliary control module may provide a signal to the central control module and the central control module may control the auxiliary HVAC. The auxiliary HVAC may be free of a discrete control module. The auxiliary HVAC may include one or more microprocessors in the AMD, the heater module, or both.

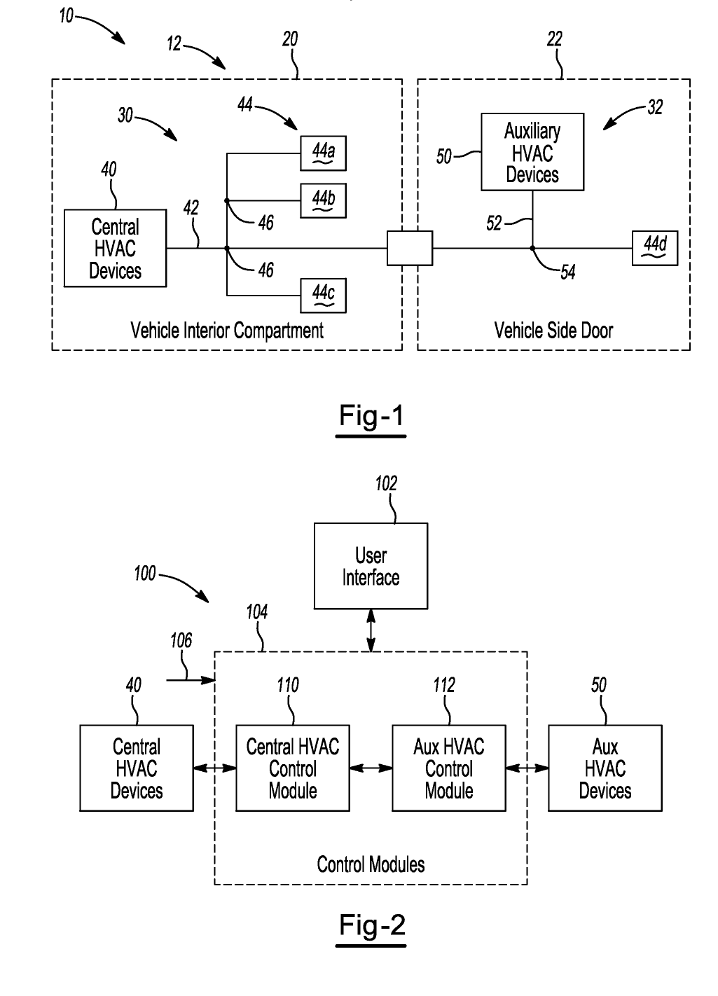

FIG. 1 is block diagram schematically illustrating a vehicle 10 including an exemplary HVAC system 12 according to the present disclosure. The vehicle 10 includes an interior compartment 20 and two or more side doors 22. For simplicity, a single side door 22 is shown. The HVAC system 12 includes a central HVAC system 30 located generally within the interior compartment 20 and an auxiliary HVAC system 32 located generally within the side door 22. The central HVAC system 30 and the auxiliary HVAC system 32 can be operated alone or in combination to regulate an air temperature and optionally humidity within the interior compartment 20 and clear frost and fog from side windows of the side doors 22.

The central HVAC system 30 includes various central HVAC devices 40 that produce conditioned air and force the conditioned air through ducting 42 and vents 44 into the interior compartment 20 and the side doors 22. The ducting 42 can include ducting for windshield vents 44a, dash vents 44b, floor vents 44c, and side door vents 44d. The central HVAC system 30 can further include one or more valves 46 for independently controlling air flow to the vents 44. The auxiliary HVAC system 32 includes various auxiliary HVAC devices that produce conditioned air and force the conditioned air through ducting 52 connecting the auxiliary HVAC system 32 to the central HVAC system 30. The auxiliary HVAC system 32 can further include one or more valves 54 for proportioning conditioned air produced by the central and auxiliary HVAC systems 30 and 32 to one or more of the vents 44.

FIG. 2 is block diagram schematically illustrating an exemplary HVAC control system 100 for the vehicle 10 according to the present disclosure. The control system 100 includes a user interface 102 and one or more control modules 104 that control operation of the central and auxiliary HVAC devices 40 and 50 based on user input to the user interface 102 and other inputs 106. The user interface 102 can include a combination of one or more buttons, controls, interactive displays, etc. permitting user input. The control modules 104 can include a central HVAC control module 110 dedicated to controlling operation of the central HVAC devices 40 which communicates with a separate auxiliary HVAC control module 112 dedicated to controlling operation of the auxiliary HVAC devices 50.

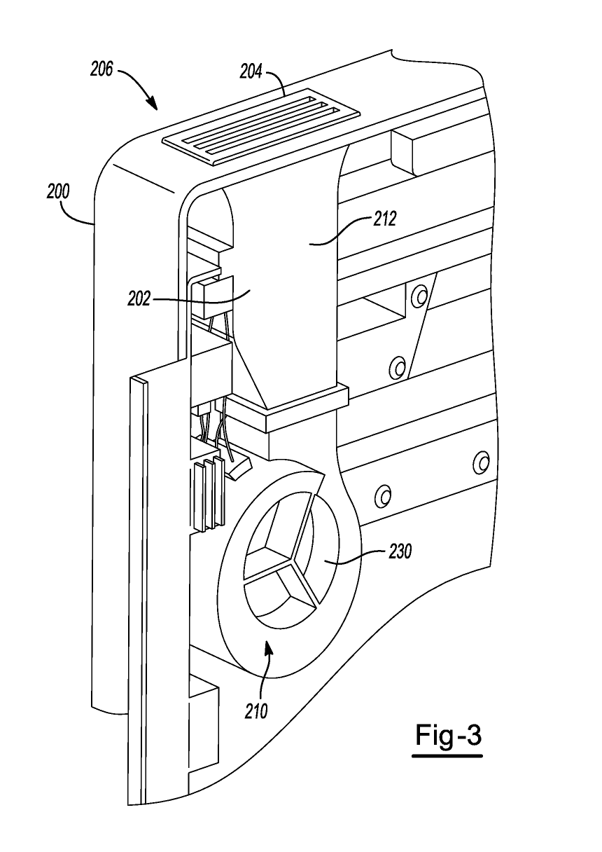

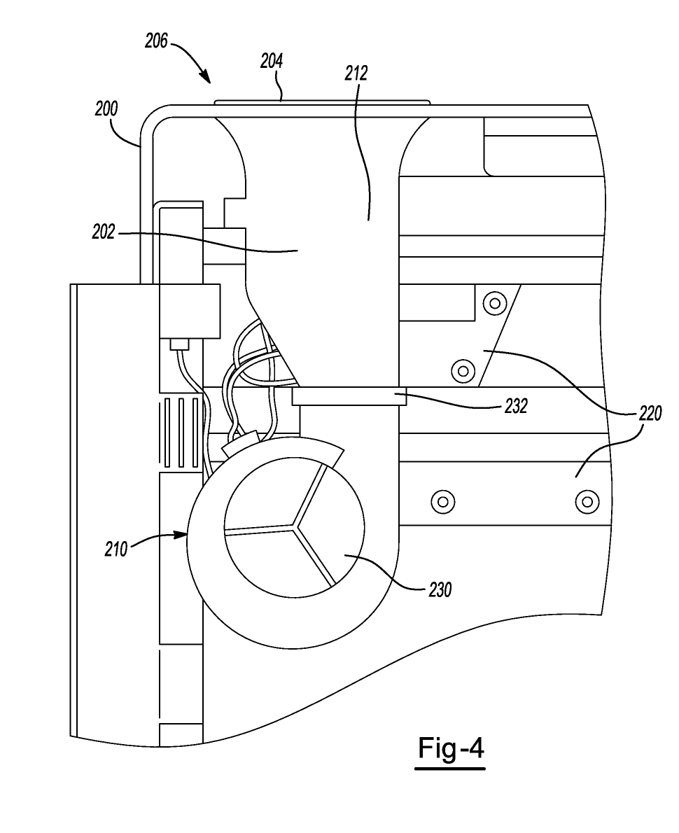

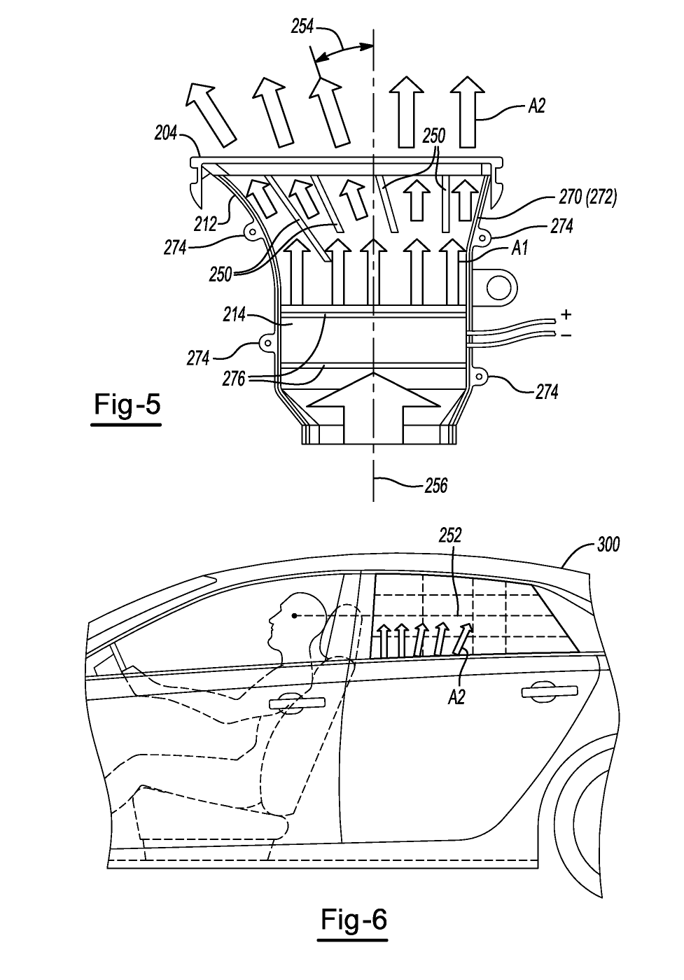

FIGS. 3-5 are views of an exemplary side door trim panel 200 for a side door of a vehicle (e.g. vehicle 10) according to the present disclosure. The side door trim panel 200 mounts to a door structure (not shown) and includes a side window conditioning module 202 located on a side facing the door structure (i.e. away from the interior compartment 20) and an escutcheon 204 defining a vent 206. The side window conditioning module 202 is separate from central HVAC devices (not shown) and is dedicated to defrosting and defogging an adjacent side door window (not shown). The side window conditioning module advantageously blows conditioned air at higher temperatures over a larger area of the side door window than conventional systems.

The side window conditioning module 202 includes an air moving device (AMD) 210, ducting 212, and a heater module 214. The AMD 210 includes one or more attachments 220 that secure the AMD 210 to the side door trim panel 200. The AMD 210 draws air through an inlet 230 and forces the air out through an outlet 232. The ducting 212 couples to the outlet 232 on one end and the escutcheon 204 at an opposite end, and fluidly couples the AMD 210 to the vent 206. The ducting 212 includes a plurality of deflectors 250 that direct air exiting the heater module 214 (air at arrows A1) out through the vent 206 in a predetermined fan-shaped pattern (air at arrows A2) generally centered around an eye-level 252 of a vehicle occupant. The deflectors 250 can be generally flat and disposed at various angles 254, and more particularly progressively greater angles, with respect to a longitudinal axis 256. The deflectors 250 can vary in length, and the length can be proportional to the angle 254. The ducting 212 also houses the heater module 214 and provides a pass through 260 for wiring of the heater module 214. The ducting 212 can have a two-piece or clamshell construction including longitudinally adjoining parts 270, 272 joined by attachments 274. Alone or together, each of the ducting parts 270, 272 can include retainers 276 that locate and hold the heater module 214 in place. The heater module 214 heats air received from the AMD 210 as the air passes through the heater module 214. In a preferred embodiment, the heater module 214 can include a positive temperature coefficient (PTC) heater. In other embodiments, the heater module 214 can include other resistive-type heaters, thermoelectric heaters, or any other heater type. In thermoelectric embodiments, the heater module 214 can be configured to cool air.

FIG. 6 is a side view schematically illustrating operation of the side window conditioning module 202 in a rear side door 300.

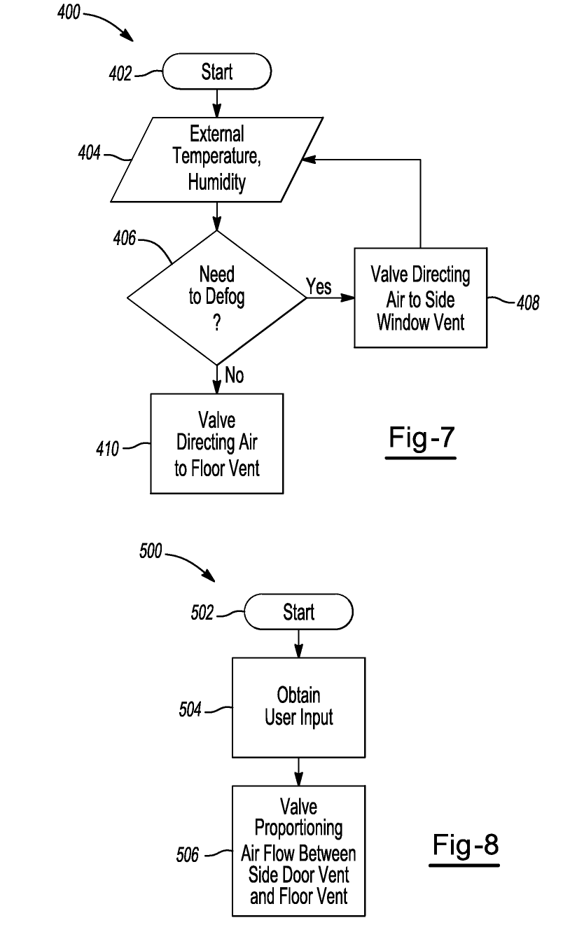

FIG. 7 is a flow diagram illustrating an exemplary control method 400 for an auxiliary HVAC system for a vehicle, and more particularly a side door window conditioning system, according to the present disclosure. The control method 400 can be implemented in one or more of the control modules of an HVAC control system (e.g. control modules 104 of control system 100). Steps in the control method 400 can define a control loop performed every predetermined period. The method 400 begins at step 402 and proceeds to step 404 where the controller obtains temperature and humidity inputs for determining whether to defog in a subsequent control step. The temperature and humidity inputs can include one or more of a temperature of the air exterior of the vehicle (“exterior temperature”), a temperature of the air in interior compartment 20 (“interior temperature”), and a humidity of the air in the interior compartment (“interior humidity”). At step, 406 control determines whether to defog the side window based on the temperature and humidity inputs. Control first determines a dew point of the air in the interior by looking up the dew point in a lookup table stored in memory based on the interior humidity, and then determines whether to defog based on a comparison of the dew point and one or more temperature inputs.

In a first example, control assumes the side window is at a temperature at or near the exterior temperature and compares the exterior temperature and the dew point. According to the first example, the side window may be at or near the exterior temperature after prolonged periods when the vehicle is idle and/or the vehicle is operated at higher speeds. In a second example, control assumes the side window is at a temperature at or near the interior temperature and compares the interior temperature and the dew point. According to the second example, the side window temperature may be at or near the interior temperature when the central HVAC system 30 has been operated for a prolonged period. In a third example, control assumes the side window temperature is within a temperature range between the exterior temperature and the interior temperature and compares the temperature range and the dew point. In a fourth example, control determines an estimated temperature of the side window based on a temperature model. In each example, the lookup table or temperature model can include a predetermined temperature offset to account for a thermal resistivity of the side window glass, or to initiate defogging of the side window in a predictive sense before condensation forms, thereby preventing condensation.

According to the examples, if the temperature used for the comparison is less than the dew point, then control determines to defog (i.e. control answers yes). If yes, then control continues at step 408 where control operates a valve (e.g. valve 54) directing all or substantially all of the air provided by the side window conditioning system to the side door vent (e.g. vent 44d). If no, then control continues at step 410 where control operates one or more valves (e.g. valve 46 and/or valve 54) directing all or substantially all of the air provided by the side window conditioning system to the floor vent (e.g. vent 44c). From step 408 and step 410, control can return to start at step 402.

FIG. 8 is a flow diagram illustrating an exemplary control method 500 for an auxiliary HVAC system for a vehicle, and more particularly a side door window conditioning system, according to the present disclosure. The control method 500 begins at step 502 and proceeds to step 504 where control obtains a user input via a user interface (e.g. user interface 102) indicating whether side window defogging and/or foot warming is desired. At step 506 control operates one or more valves (e.g. valve 46 and/or valve 54) proportioning air provided by the side window conditioning system to the floor vent 44c and the side door vent 44d.

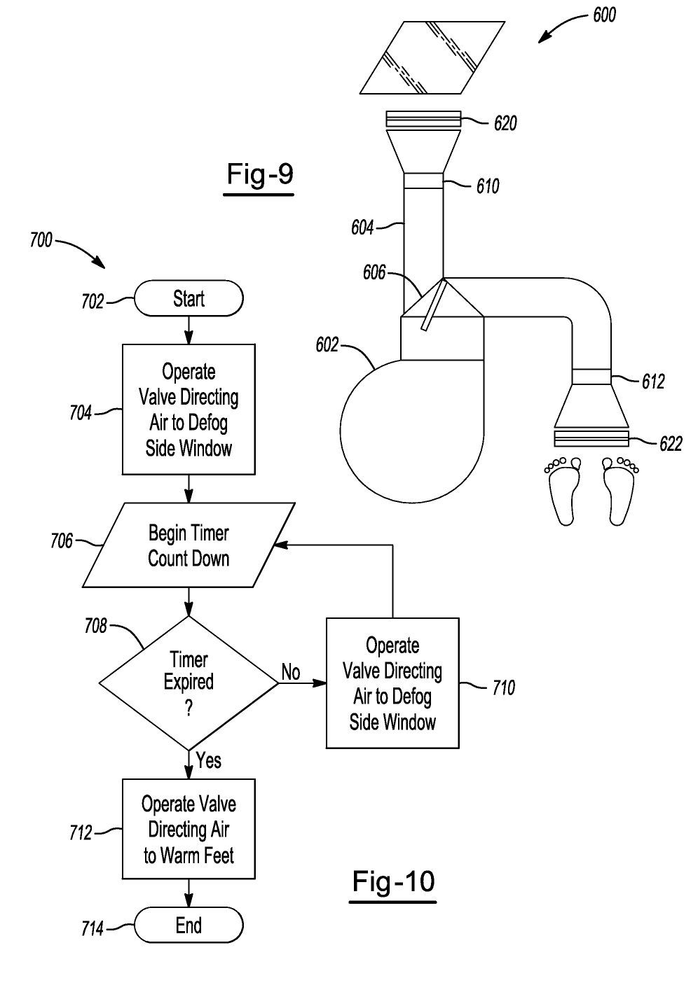

FIG. 9 is a schematic view of another auxiliary HVAC system 600 according to the present disclosure. The auxiliary HVAC system 600 includes a single outlet blower 602, ducting 604, a proportioning valve 606, and heaters 610, 612 located near respective side window and floor vents 620 and 622. The auxiliary HVAC system 600 provides a combined demister and foot-warmer sharing a common forced air source, blower 602. The proportioning valve 606 proportions forced air between the vents 620, 622. The distribution can be controlled by an electronic circuit including a control module, an exterior temperature sensor, an interior temperature sensor, an exterior humidity sensor, an interior humidity sensor (all not shown) or some combination thereof. The electronic circuit can direct air flow toward the side window vent of the system when the external temperature, external humidity, internal temperature, internal humidity or some combination thereof indicate a need to demist the window. When not demisting, the air flow can be directed toward the floor vent. The power output to the heaters 610, 612 can be controlled by the electronic circuit and a feedback control loop with the interior temperature sensor. The electronic circuit can also control the distribution of air between the side window vent and the floor vent based on a timer such that after a pre-determined time, the system automatically directs more air toward the foot-warmer outlet.

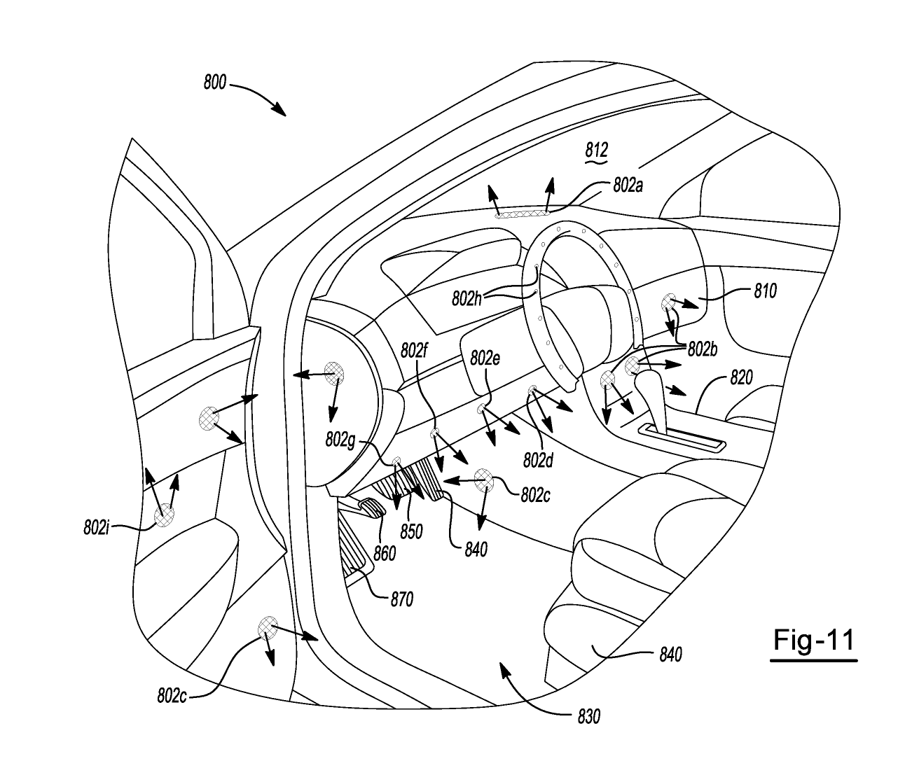

FIG. 10 is a flow diagram illustrating another exemplary control method 700 for an auxiliary HVAC system for a vehicle according to the present disclosure, and more particularly a side door window conditioning system that is used to condition both a side door window and an occupant's feet. The system includes a timer and the control method 700 uses the timer to determine when to switch and/or apportion conditioned air flow between vents directed to a side window and vents directed to the occupant's feet. The control method 700 can be implemented in one or more of the control modules of an HVAC control system according to the present disclosure. Steps in the control method 700 can define a control loop performed every predetermined period. The method 700 begins at 702 and proceeds at 704 where control begins operating a valve to direct all or substantially all of the conditioned air from an auxiliary HVAC system to defog the side door window. Control proceeds at 706 where control begins a timer counting down. Control proceeds at 708 where control determines whether the timer has expired. If no, control proceeds at 710 otherwise control continues at 712. At 710, control continues to operate the valve to direct conditioned air to defog the side window and continues at 706 and 708 for another control loop. At 712, control operates a valve to discontinue directing conditioned air to defog the side window and begin directing all or substantially all of the conditioned air from the auxiliary HVAC system to warm the occupant's feet. Control may continue at 712 for a predetermined period or until the auxiliary HVAC system is shut off and control ends at 714.

FIG. 11 is a perspective view illustrating an exemplary vehicle 800 and vents 802 in fluid communication with a central HVAC system 804 and an auxiliary HVAC system 806 for the vehicle 800. The vents 802 can be fluidly connected by ducting, and air to the vents 802 can be independently controlled by one or more valves disposed at least partially in the ducting. The vents 802 include windshield vents 802a, dash vents 802b, floor vents 802c-g, steering wheel vents 802h, and side door vents 802i. The windshield vents 802a can be located on an upper surface of a dash panel 810 to direct air towards a windshield 812. The dash vents 802b can be located on a rearward facing surface of the dash panel 810 and/or a center console 820. The floor vents 802c can be located on sides of the dash panel 810 and/or the center console 820 to direct air generally towards a foot well 830 in front of and below occupant seats 840. The floor vents 802c can also be located in a lower portion of a side of the side doors to direct air towards the foot well 830. Floor vents 802d-g can be located on a downward facing side of the dash panel 810 to direct air towards a top of the occupant's feet. Floor vents 802d can direct air towards a gas pedal 840 and, more particularly a top of the occupant's right foot when present on the gas pedal 840. Floor vents 802e-f can direct air towards a brake pedal 850 and a clutch pedal 860 and, more particularly a top of the occupant's left foot and/or right foot when present on the brake pedal 850 and the clutch pedal 860. Floor vents 802g can direct air towards a so-called dead pedal 870 where the occupant rests the left foot, and more particularly the top of the left foot when present on the dead pedal 870. The steering wheel vents 802h can be located on or near a steering wheel 880, for example on a steering column supporting the steering wheel 880, to direct air towards the occupants hands when present on or located near the steering wheel 880. More particularly, the steering wheel vents 802h can be located and configured to direct air towards palms of the occupant's hands.

In various embodiments, the auxiliary HVAC system 806 can receive conditioned air from the central HVAC system 804 and selectively heat or cool the air by a predetermined amount. The auxiliary HVAC system 806 can selectively direct the heated or cooled conditioned air to one or more of the vents 802 so that the conditioned air exiting the selected vents is at a different temperature than conditioned air exiting other vents 802. In this way, the auxiliary HVAC system 806 can be used to vary and control the temperature within selected zones of the interior. In a preferred embodiment, the auxiliary HVAC system 806 selectively heats or cools conditioned air from the central HVAC system 804 by a predetermined amount. The auxiliary HVAC system directs the conditioned air to one or more of the floor vents 802e-g and the steering wheel vents 802h to heat or cool the occupant's feet and/or hands at a different temperature than that of the conditioned air directed to other parts of the occupant's body. By heating or cooling the occupant's feet and/or hands, areas of the occupant's body more receptive to heat transfer than other areas, the auxiliary HVAC system 806 can increase occupant comfort while reducing demand on the central HVAC system 804.

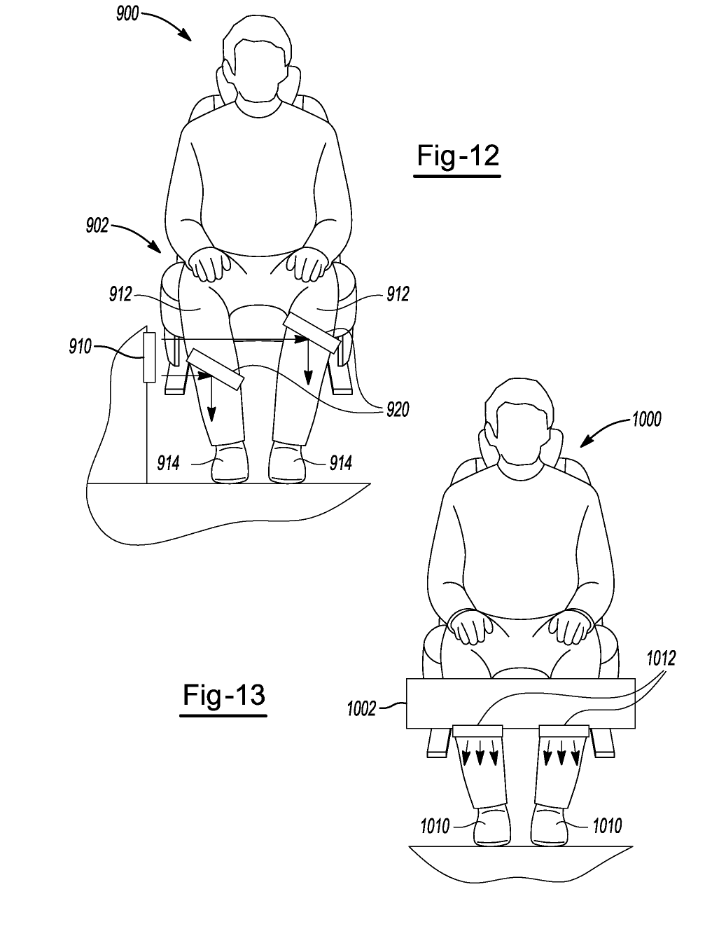

FIG. 12 is a front view of another vehicle 900 including an exemplary auxiliary HVAC system 902 according to the present disclosure. The auxiliary HVAC system 902 is in fluid communication with a floor vent 910 that directs air horizontally towards an occupant's legs 912. The auxiliary HVAC system 902 includes one or more deflectors 920 that direct the air from the floor vent 910 downwards towards the top of the occupant's feet 914 as illustrated by the arrows. In various embodiments, the deflectors 920 can be attached to a dash, a pedal assembly, or other suitable location of the vehicle 900.

FIG. 13 is a front view of another vehicle 1000 including an exemplary auxiliary HVAC system 1002 according to the present disclosure. The auxiliary HVAC system 102 is located above an occupant's feet 1010 and includes one or more vents 1012 that direct conditioned air from the auxiliary HVAC system 1002 towards tops of the occupant's feet 1010. In various embodiments, the auxiliary HVAC system 1002 can be attached to a dash, a pedal assembly, or other suitable location of the vehicle 1000. The auxiliary HVAC system 1002 can be fluidly connected to a central HVAC system (not specifically shown) via ducting, or alternatively stand alone. In standalone systems, the auxiliary HVAC system 1002 can draw air in from a foot well area, heat or cool the air, and direct the conditioned air towards the occupant's feet 1010.

Various embodiments of the auxiliary HVAC systems 902, 1002 and other auxiliary HVAC systems according to the present disclosure can be configured to receive an input from an occupant that allows the occupant to set a heating or cooling mode, or a temperature of the conditioned air based on a type of footwear worn by the occupant. In this way, the occupant can increase the amount of heating or cooling when wearing, for example heavy, insulated boots, or decrease the amount of heating or cooling when wearing, for example open-toed shoes or sandals.

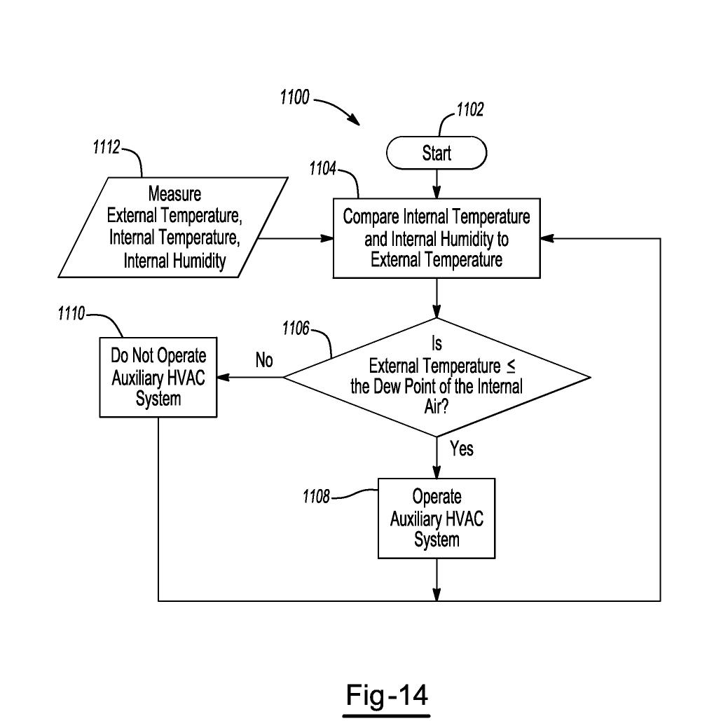

FIG. 14 is a flow diagram illustrating a control method 1100 for an auxiliary HVAC system for a vehicle, and more particularly a side door window conditioning system, according to the teachings herein. The control method 1100 begins at step 1102 and upon beginning the control method begins measuring 1112 ambient conditions such as external temperature, internal temperature, internal humidity, or a combination thereof using one or more sensors. The measured 1112 ambient conditions are then relayed where at step 1104 the measured ambient conditions are compared. As shown in step 1104 the internal ambient conditions (i.e., internal temperature and internal humidity) is compared to external ambient conditions (i.e., external temperature). The compared information is relayed to step 1106 where the compared information is compared to the dew point to determine whether the auxiliary HVAC system is turned on in step 1108 or if the auxiliary HVAC system remains off in step 1110. Regardless of whether the auxiliary HVAC system is turned off (or remains off) in step 1110 or is turned on (or remains on) in step 1108 the compared data is continually compared to the dew point of the internal air and the system is switched on or off once the temperature drops below the dew point.

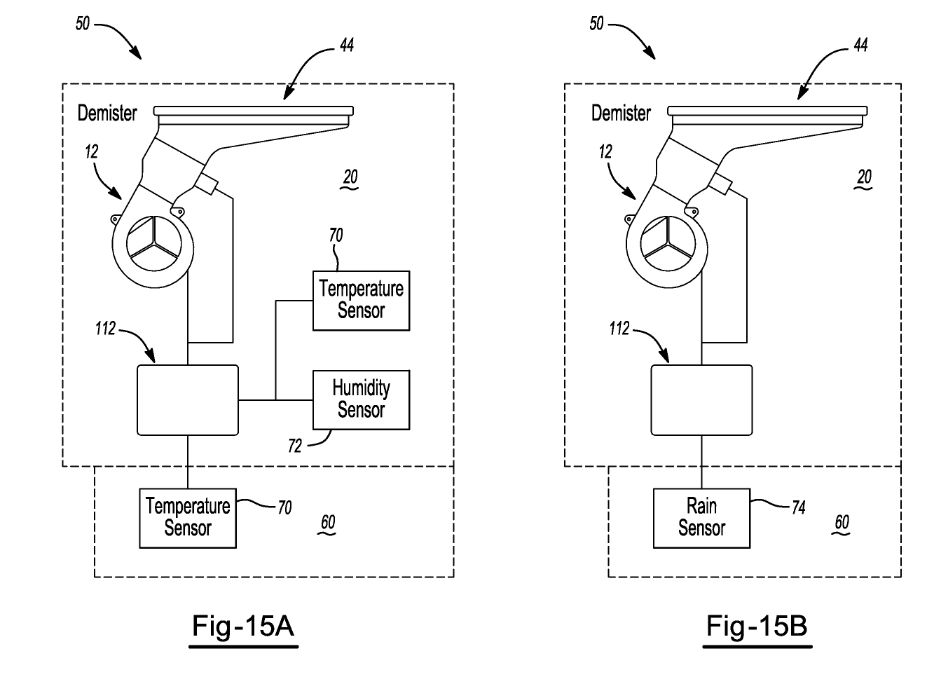

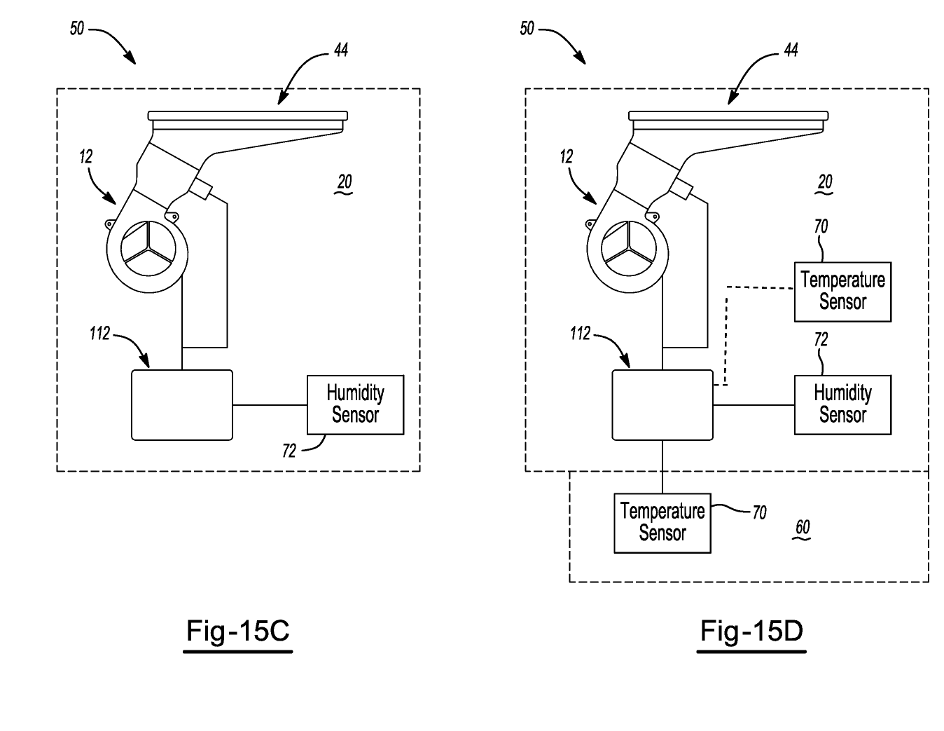

FIG. 15A is a schematic view of an auxiliary HVAC system 50. The auxiliary HVAC system 50 includes an air moving device 12 connecting to venting 44. The air moving device 12 is controlled by an auxiliary control module 112. The auxiliary control module 112 is connected to sensors that are located within the interior compartment 20 of a vehicle and sensors that are located in the exterior of the vehicle 60. The interior compartment 20 includes a temperature sensor 70 and a humidity sensor 72 for monitoring the ambient conditions within the interior compartment 20. The exterior of the vehicle 60 includes a temperature sensor 70 for monitoring the external ambient conditions.

FIG. 15B is a schematic view of an auxiliary HVAC system 50. The auxiliary HVAC system 50 includes an air moving device 12 connecting to venting 44. The air moving device 12 is controlled by an auxiliary control module 112. The auxiliary control module 112 is connected to sensors that are located in the exterior of the vehicle 60. The interior compartment 20 does not include any sensors. The exterior of the vehicle 60 includes a rain sensor 74.

FIG. 15C is a schematic view of an auxiliary HVAC system 50. The auxiliary HVAC system 50 includes an air moving device 12 connecting to venting 44. The air moving device 12 is controlled by an auxiliary control module 112. The auxiliary control module 112 is connected to sensors that are located within the interior compartment 20 of a vehicle. The interior compartment 20 includes a humidity sensor 72 for monitoring the ambient conditions within the interior compartment 20.

FIG. 15D is a schematic view of an auxiliary HVAC system 50. The auxiliary HVAC system 50 includes an air moving device 12 connecting to venting 44. The air moving device 12 is controlled by an auxiliary control module 112. The auxiliary control module 112 is connected to sensors that are located within the interior compartment 20 of a vehicle. The exterior of the vehicle 60 as shown does not include any sensors. The interior compartment 20 includes a temperature sensor 70 and a humidity sensor 72 for monitoring the ambient conditions within the interior compartment 20. The temperature sensor 70 is part of the automobile and is not part of the auxiliary HVAC device 50. The auxiliary control module 112 monitors the temperature and humidity inside and controls the auxiliary HVAC device 50 when the humidity exceeds a predetermined humidity at a given temperature.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. An automotive heating, ventilation, and air-conditioning (HVAC) system for an interior of a vehicle, comprising:
one or more auxiliary HVAC systems that provides conditioned air to the interior, the one or more auxiliary HVAC systems including an auxiliary air conditioning device;
a control module that operates the one or more auxiliary HVAC systems independently of a central HVAC system; and
one or more sensors;
wherein the central HVAC system provides conditioned air to the interior, and the central HVAC system includes a central air conditioning device that is separate from the auxiliary air conditioning device; and
wherein the central HVAC system directs conditioned air toward a foot well of the interior, and at least one of the one or more auxiliary HVAC systems direct conditioned air towards the foot well.

2. The automotive HVAC system of claim 1, wherein at least one of the one or more auxiliary HVAC systems is located in a side door of the vehicle and directs the conditioned air towards a side door window for defogging the side door window.

3. The automotive HVAC system of claim 1, wherein the one or more auxiliary HVAC systems includes:
an air moving device; and
ducting that includes a plurality of deflectors for directing the conditioned air in a fan-shaped pattern, wherein the deflectors are generally flat and arranged at progressively greater angles with respect to a longitudinal axis and at least one of the deflectors is longer than the remaining deflectors, and wherein
the second air conditioning device is secured within the ducting between the air moving device and the plurality of deflectors.

4. (canceled)

5. The automotive HVAC system of claim 1, wherein the at least one auxiliary HVAC system is mounted to move with a pedal assembly of the vehicle to direct the conditioned air within the foot well to a top of an occupant's foot.

6. The automotive HVAC system of claim 1, wherein the control module operates the central HVAC system and the one or more auxiliary HVAC systems to provide conditioned air at a first temperature and a second temperature, respectively, and wherein the first and second temperatures differ by a predetermined difference.

7. The automotive HVAC system of claim 1, wherein the control module directs conditioned air from the one or more auxiliary HVAC systems towards a window for a first period, and then directs conditioned air from the one or more auxiliary HVAC systems away from the window towards the interior for a second period following the first period.

8. The automotive HVAC system of claim 1, wherein the control module controls operation of the central HVAC system based on an occupant input, and controls operation of the one or more auxiliary HVAC systems based on a measured air temperature and a measured humidity.

9. The automotive HVAC system of claim 1, wherein the one or more sensors are an internal temperature sensor, an internal humidity sensor, an external temperature sensor, an external humidity sensor, a rain sensor, an internal pressure sensor, an external pressure sensor, or a combination thereof.

10. The automotive HVAC system of claim 3, wherein the ducting includes one or more proportioning valves for directing air between two or more locations.

11. The automotive HVAC system of claim 1, wherein the control module includes one or more look up tables for calculating dew point based upon an input from the one or more sensors.

12. A method comprising:
a. providing the one or more auxiliary HVAC systems of claim 1 within the interior of an automotive vehicle;
b. monitoring one or more ambient conditions with the one or more sensors; and
c. automatically operating the auxiliary HVAC system when a predetermined condition is met.

13. The method of claim 12, wherein the proportioning valve is actuated once the ambient conditions no longer support that fog, ice, condensation, or a combination thereof of present on the one or more windows of the automobile.

14. The method of claim 12, wherein the auxiliary air conditioning device is a heater module and the heater module is activated to heat air.

15. The method of claim 12, wherein the auxiliary HVAC system includes one or more air moving devices that move air into contact with the one or more windows.

16. A method comprising:
a. providing the one or more auxiliary HVAC systems of claim 1,
b. locating the one or more auxiliary HVAC systems within the interior space of an automotive vehicle;
c. monitoring one or more ambient conditions with the one or more sensors;
d. determining whether a predetermined condition is met; and
e. automatically operating the one or more auxiliary HVAC systems when the predetermined condition is met and turning the one of more auxiliary HVAC systems off when the predetermined condition is no longer met; and
wherein the method includes a step of turning on a heater module, one or more fans, or both.

17. The method of claim 16, wherein the method includes a step of turning on a heater module, one or more fans, or both.

18. The method of claim 15, wherein the method includes a step of automatically directing the air to one or more locations within the interior space of the automotive vehicle.

19. The automotive HVAC system of claim 2, wherein the one or more auxiliary HVAC systems includes:
an air moving device; and
ducting that includes a plurality of deflectors for directing the conditioned air in a fan-shaped pattern, wherein the deflectors are generally flat and arranged at progressively greater angles with respect to a longitudinal axis and at least one of the deflectors is longer than the remaining deflectors, and wherein
the second air conditioning device is secured within the ducting between the air moving device and the plurality of deflectors.

20. The automotive HVAC system of claim 19, wherein the at least one auxiliary HVAC system is mounted to move with a pedal assembly of the vehicle to direct the conditioned air within the foot well to a top of an occupant's foot.

21. The automotive HVAC system of claim 20, wherein the control module operates the central HVAC system and the one or more auxiliary HVAC systems to provide conditioned air at a first temperature and a second temperature, respectively, and wherein the first and second temperatures differ by a predetermined difference.
